(19) United States
(12) Patent Application Publication
(10) Pub. No.: US 2002/0144454 A1
(43) Pub. Date: Oct. 10, 2002

(54) Flying insect repellant system utilizing forced air in an exterior area

(76) Inventor: Jay F. Seniff, New Carlisle, IN (US)

Correspondence Address: Todd T. Taylor, TAYLOR & AUST, P.C., 142 S. Main St., P.O. Box 560, Avilla, IN, 46710, US

(21) Appl. No.: 09/826,615

(22) Filed: Apr. 5, 2001

(51) Int. Cl. A01M 5/08

(52) U.S. Cl. 43/141

(57) ABSTRACT

A flying insect repellant system includes a duct system, a blower, and a plurality of delivery mechanisms. The duct system has an intake end and a least one exhaust end for the delivery of air. The blower is connected to the intake end of the duct system. A plurality of delivery mechanisms, conjunctively defining a perimeter, each have at least one orifice and are connected to an exhaust end of the duct system. Each delivery mechanism is configured for creating a boundary of moving air sufficient to inhibit flying insects from penetrating therethrough.

### BACKGROUND OF THE INVENTION

1. Field of the Invention

The present invention relates to insect repellant systems, and, more particularly, to forced air insect repellent systems.

2. Description of the Related Art

The enjoyment which people seek in the out of doors is often diminished when flying insects encroach in the same area. Various methods have been used to reduce the presence of insects in exterior areas. Some rely on the attraction of insects to a device that will kill or trap them. Many utilize chemical repellents which are applied to the exposed skin, dispersed in the air by burning or mechanical means, or applied to the ground in an area desired to be free of insects. Chemical applications are also used to simply kill insects in an area.

When it is desirable to exclude flying insects in the area of a doorway or a window of a building, particularly if the doorway or window is in the vicinity of light or odors which attract flying insects, the use of a device that provides an airflow across the opening may be used to discourage flying insects from entering an open door or window or alighting on the door or window. Such a system thus has been used in conjunction with openings in buildings which are otherwise impervious to flying insects, offering protection to those inside the building or immediately adjacent to the building, but not in open areas.

Insect repellent systems have been integrated into furniture which utilize air nozzles to force air around the occupant. Such furniture is designed to provide air stream barriers around the furniture's occupant, particularly around areas of exposed skin to discourage flying insects from alighting on the occupant. The use of an airflow issuing from a piece of furniture to prevent flying insects from alighting on an individual has the drawback of requiring the person to remain in place on the furniture in order to receive the benefit afforded by the airflow.

What is needed in the art is a device that can be used to exclude flying insects from an exterior area without the use of chemicals, insect traps or the necessity of walls or enclosures.

### SUMMARY OF THE INVENTION

The present invention provides a flying insect repellant system in an exterior area by providing a perimeter boundary of moving air.

The invention comprises, in one form thereof, a device for the exclusion of flying insects from an exterior area which includes a duct system, a blower and a plurality of delivery mechanisms. The duct system has an intake end and a least one exhaust end for the delivery of air. The blower is connected to the intake end of the duct system. A plurality of delivery mechanisms, conjunctively defining a perimeter, each have at least one orifice and are connected to an exhaust end of the duct system. Each delivery mechanism is configured for creating a boundary of moving air sufficient to inhibit flying insects from penetrating therethrough.

An advantage of the present invention is that it will assist in causing an exterior area to be free of flying insects.

Another advantage is that the insect free area is created without the use of chemicals or the trapping and killing of insects.

Yet another advantage is that the moving air will serve to keep the air in an area fresher and more pleasant to the occupants.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic, perspective illustration of a flying insect repellant system according to an embodiment of the invention;

FIG. 2 is a schematic, perspective illustration of a set of risers and railings of another embodiment of the flying insect repellent system of the present invention;

FIG. 3 is a front view of an embodiment of a riser configured for the top discharge of air; and

FIG. 4 is a side view of an embodiment of a riser configured for the angular discharge of air.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

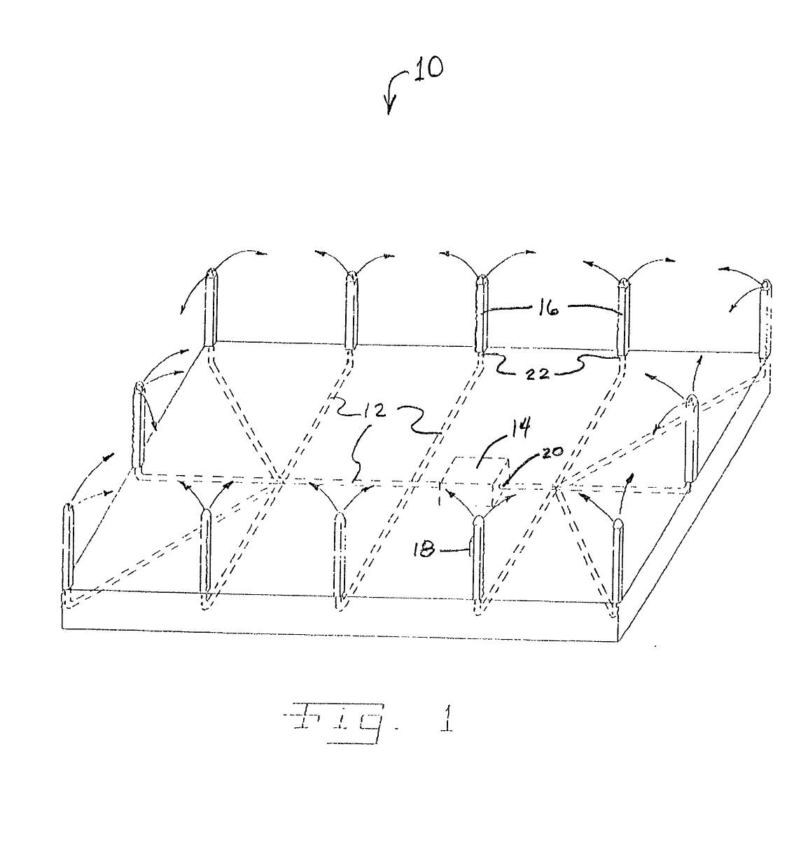

Referring now to the drawings, and more particularly to FIG. 1, there is shown a flying insect repellant system 10 including a duct system 12, a blower 14, a plurality of delivery mechanisms 16 and a control system 18.

Duct system 12 is configured with an intake end 20 and a plurality of exhaust ends 22, to deliver airflow from blower 14 to each delivery mechanism 16. In one embodiment of the invention, duct system 12 would be installed under a porch, deck, patio or yard (not labeled) with exhaust ends 22 being configured to connect to delivery mechanisms 16, shown as risers. Intake end 20 can be located in the area desired to be free of flying insects, such as under a deck, or it can be located in such a manner as to bring fresh air into the area and/or to lessen the potential distraction which any noise that may be generated by blower 14 may create.

Blower 14 forces air into intake end 20 of duct system 12. In one embodiment of the invention, blower 14 may be a squirrel cage blower attached to an electric motor.

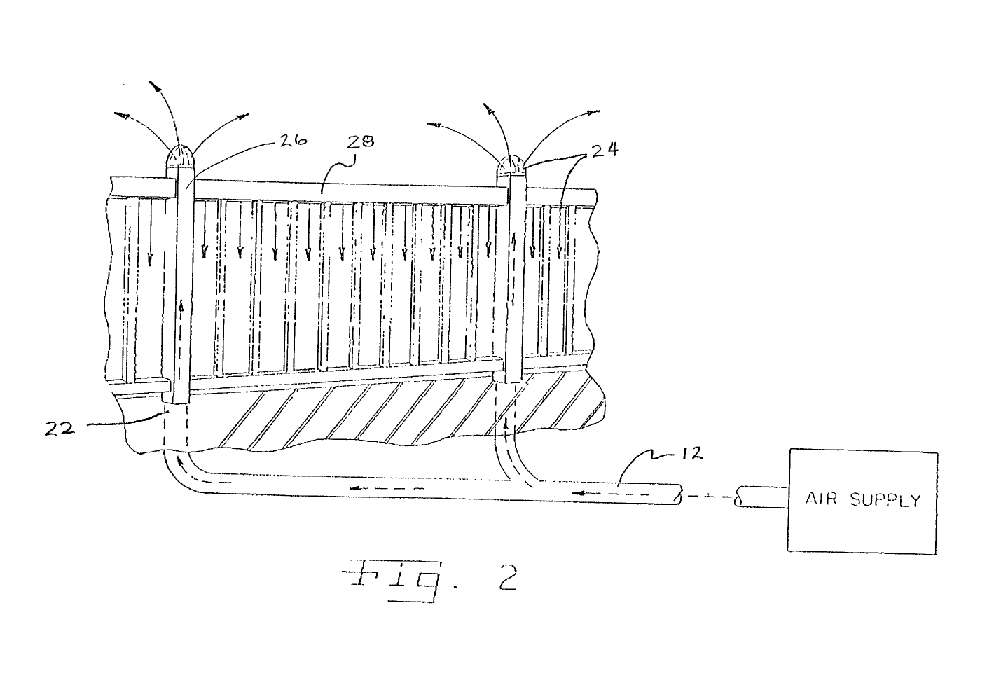

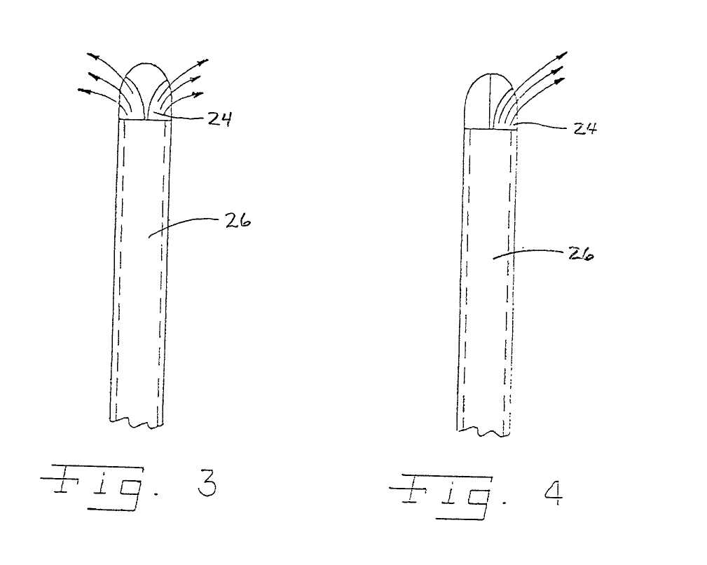

Delivery mechanisms 16 are configured with internal air passageways and are connected to exhaust ends 22 of duct system 12 for the delivery of the airflow to orifices 24 which are a part of each delivery mechanism 16. Orifices 24 are so directed as to provide a flow of air into the surrounding atmosphere to create an airflow boundary to inhibit the intrusion of flying insects. In one embodiment of the invention, delivery mechanisms 16 may be some combination of risers 26 and/or railings 28, such as shown in FIG. 2, where risers 26 and railings 28 are configured with orifices 24 for the discharge of air creating an airflow boundary. The orientation of some orifices 24 will include, but not be limited to, top discharge as shown in the riser of FIG. 3, and the discharge, of air oriented to provide an overhead airflow boundary, as illustrated in FIG. 4.

Integrating the delivery mechanisms 16 into structures, such as risers 26 and railings 28, that routinely appear around decks, porches, patios and yards, provides for a system that is unobtrusive to the aesthetics of an outdoor space. By the manner of a particular installation, the airflow boundary may be directed in a combination of directions to form the desired boundary for the exclusion of flying insects.

Control system 18 is connected to blower 14 for the purpose of varying the airflow which blower 14 delivers to duct system 12. In one embodiment of the invention, control system 18 is an electronic control of an electric motor which powers a fan of blower 14 at a desired operating speed.

During operation, and referring to FIG. 1, duct system 12 directs an airflow provided by blower 14 at intake end 20 of duct system 12 to a plurality of exhaust ends 22 of duct system 12. Delivery mechanisms 16 receive airflow from each exhaust end 22 and disburse the air through orifices 24 causing the creation of an airflow boundary for the exclusion of flying insects. Control system 18 allows control over the speed of blower 14, thus controlling the velocity of the air in the system and the intensity of the airflow boundary.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A flying insect repellant system, comprising:
a duct system with an intake end and at least one exhaust end for the delivery of air;
a blower connected to said intake end; and
a plurality of delivery mechanisms, conjunctively defining a perimeter, each said delivery mechanism having at least one orifice and being connected to one of said exhaust ends, each said delivery mechanism being configured for creating a boundary of moving air sufficient to inhibit flying insects from penetrating therethrough.

2. The flying insect repellant system of claim 1, further including control system coupled to said blower for the control of the amount of air forced into said duct system.

3. The flying insect repellant system of claim 2, wherein said control system comprises an electrical control.

4. The flying insect repellant system of claim 1, wherein said perimeter defines one of a patio, porch, deck and yard.

5. The flying insect repellant system of claim 1, wherein said delivery mechanisms include risers and railings.

6. The flying insect repellant system of claim 5, wherein said risers and said railings each have at least one internal air passageway and at least one orifice in fluid communication with said at least one internal air passageway.

7. The flying insect repellant system of claim 1, wherein each said orifice is a nozzle.

8. The flying insect repellant system of claim 1, wherein said blower is an electric blower.

9. The flying insect repellant system of claim 1, wherein said duct system is constructed of plastic pipe.

10. A method of excluding flying insects from an area using directed airflow, said method comprising the steps of:
providing a blower, duct system, coupled to said blower and a plurality of delivery mechanisms coupled to said duct system and conjunctively defining a perimeter;
generating an airflow in said duct system, with said blower;
distributing the airflow through said duct system and into said plurality of delivery mechanisms; and
directing a portion of said airflow through each said delivery mechanism in an amount sufficient to create a boundary of moving air around sad perimeter so as to inhibit flying insects from penetrating therethrough.

11. The method of excluding flying insects of claim 10, further comprising the step of controlling the velocity of the airflow by controlling the speed of said blower.
